(19) United States
(12) Patent Application Publication
(10) Pub. No.: US 2017/0345026 A1
(43) Pub. Date: Nov. 30, 2017

(54) GROUPING USERS INTO MULTIDIMENSIONAL TIERS BASED ON SIMILARITY TO A GROUP OF SEED USERS

(71) Applicant: Facebook, Inc., Menlo Park, CA (US)

(72) Inventors: Gianluca Iannaccone, Oakland, CA (US); Noah Zachary Burger Choi, New York, NY (US); Jacob Schonberger, Chappaqua, NY (US)

(21) Appl. No.: 15/167,705

(22) Filed: May 27, 2016

(51) Int. Cl. G06Q 30/02

(52) U.S. Cl. CPC G06Q 30/0201

(57) ABSTRACT

An online system identifies a threshold score dividing seed users into low value seed users and high value seed users based on the initial score of each seed user. The online system identifies, as additional high value users, additional users of the online system having a measure of similarity to one or more of the high value seed users. The online system identifies, as additional engaged users, additional users of the online system having a measure of similarity to one or more of the identified seed users. The online system determines a value score for each of the additional high value users. The online system determines an engagement score for each of the additional engaged users. The online system determines one or more intersections between the value tiers of users containing the additional high value users and the engagement tiers of the additional engaged users based on the scores.

### BACKGROUND

This disclosure relates generally to online systems storing identity information for users, and in particular to grouping users into tiers based upon a computed similarity score to a group of seed users.

Certain online systems, such as social networking systems, allow their users to connect to and to communicate with other online system users. Users may create profiles on such an online system that are tied to their identities and include information about the users, such as interests and demographic information. The users may be individuals or entities such as corporations or charities. Because of the increasing popularity of social networking and others of these types of online systems and the increasing amount of user-specific information maintained by such online systems, such an online system provides an ideal forum for entities to increase awareness about products or services by presenting sponsored content to online system users.

Presenting sponsored content to users of an online system allows an entity sponsoring the content to gain public attention for products or services and to persuade online system users to take an action regarding the entity's products, services, opinions, or causes. Generally, these entities each have websites accessible to online system users. However, these entities generally do not have access to the identity information that an online system, such as a social networking system, stores and associates with users, which can be a wealth of valuable targeting information about these users. This limitation in the information available to entities providing sponsored content makes it difficult for them to effectively identify sponsored content to provide to the online system for presentation to various users and to identify which group of users is the optimal to target with this sponsored content.

In other words, the entity is limited in its ability to most efficiently target the sponsored content as the entity has less ability to identify those users of the online system that would respond in a cost effective way to the sponsored content, e.g., those users who would provide a positive return on investment that the entity makes in presenting the sponsored content to the user.

### SUMMARY

Embodiments of the invention include an online system, such as a social networking system, that is able to group users into tiers based upon a computed similarity score to a group of seed users to create tiers of lookalike users around the seed set of users. The tiers can include tiers of users grouped according to the value to the content provider in providing content to the user (e.g., high and low value users) and tiers of users grouped according to engagement levels of the user with the content (e.g., high and low engagement users). A two-dimensional grid of value and engagement tiers can be generated to see the intersections between the value and engagement tiers (e.g., high value/low engagement intersection, high engagement/low value intersection, high value/high engagement intersection), allowing the content provider and/or the online system to consider both factors in deciding to which users to target content and how to select and place bids for providing content to the users.

The online system initially identifies seed users of the online system. Each of these seed users is associated with a score indicating a value of that seed user to a third party system. To compute the score, the online system may identify for each seed user, actions performed by that seed user in response to being presented with content provided by the third party system. These actions may include liking the sponsored content, sharing the sponsored content via comments on the online system, by clicking or interacting with the sponsored content, and so on. After identifying the actions, the online system determines, for each seed user, a score weighted based on the actions performed by that seed user in response to being presented with content provided by the third party system. Some actions, such as clicking on the sponsored content, may be weighted higher by the online system than other actions, such as liking the sponsored content.

The online system identifies similar or lookalike users for the seed group that are ultimately tiered according to value (high to low value) and engagement (high to low engagement). In one embodiment, a threshold score is used in dividing the seed users into low value seed users and high value seed users based on the score of each seed user. To determine this threshold score, the online system may receive the threshold score from the content provider or may compute it. For example, the system may compute an average (or other statistical measurement, such as the median) of the scores for each seed user, and may identify as the threshold score a value that is one standard deviation above the average score.

The online system identifies one or more characteristics of each of the low value seed users and the high value seed users. These characteristics may include the actions performed by the low and high value seed users in the online system (e.g., commenting, liking, etc.), characteristics in the users' profiles (e.g., likes and dislikes), and may include the connections made by these users.

The online system identifies, as additional high value users, additional users of the online system having a measure of similarity to one or more of the high value seed users that is above a threshold measure of similarity. The measure of similarity of a first group of users and a second group of users based at least in part on characteristics of the first group of users matching one or more identified characteristics associated with the second group of users. For example, the measure of similarity may count a number of similar actions, connections, or other characteristics between two users. The online system identifies, as additional engaged users, additional users of the online system having a measure of similarity to the overall group of seed users that is above the threshold measure of similarity. This threshold measure of similarity may be set at a percentage (e.g. 75%), or may be indicated by the content provider.

The online system determines a value score for each of the additional high value users based at least in part on the measure of similarity between the additional high value user and the high value seed users. For example, the online system may determine as the value score for an additional high value user the measure of similarity for that user normalized against the score for that high value user that the online system had previously computed. The additional high value users can be placed into tiers according to their value scores, where the tiers closest to the seed high value users include users that look the most like those seed high value users, and the farther the tier, the less the users in the tier look like the seed high value users.

The online system also determines an engagement score for each of the additional engaged users. The online system determines the engagement score for an additional user based at least in part on the measure of similarity between the additional engaged user and the seed users. The additional engaged users can be placed into tiers according to their engagement scores, where the tiers closest to the seed users include users that look the most like those seed users in terms of engagement, and the farther the tier, the less the users in the tier look like the seed users.

The online system further determines one or more intersections of users between the additional high value users and the additional engaged users based on the scores. To determine these intersections, the online system may identify the additional high value users matching the additional engaged users, and divide these matched users into the one or more intersections. Each intersection includes matched users with a range of engagement scores that is contiguous with a range of engagement scores corresponding to another intersection, and each intersection includes matched users with a range of value scores that is contiguous with a range of value scores corresponding to another intersection.

Subsequently, the online system provides the intersections to the third party system for display by the online system. To do this, the online system may present the one or more intersections in a two dimensional grid or in a different type of interface. Each section of the grid represents one intersection, with one axis of the grid indicating the value score of intersections along that axis, and an orthogonal axis indicating the engagement score of intersections along the orthogonal axis. The online system may further present within each grid section statistical information for the users of the corresponding intersection.

Using such a system, a sponsored content provider may easily determine which users to target to present the sponsored content. The sponsored content provider may be able to target additional users, not simply based on simple demographic indicators, but based on more salient data indicating how the users are likely to respond to the sponsored content.

### BRIEF DESCRIPTION OF THE DRAWINGS

FIG. 1 is a high level block diagram of a system environment for an online system, according to an embodiment.

FIG. 2 is an example block diagram of an architecture of the online system, according to an embodiment.

FIG. 3 is a flowchart of one embodiment of a method in an online system for grouping users based on multi-dimensional value and engagement factors, according to an embodiment.

FIG. 4 illustrates a diagrammatic representation of a set of intersections for additional high value users and additional engaged users, according to an embodiment.

FIG. 5 illustrates an exemplary user interface for configuring a multi-dimensional set of users, according to an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

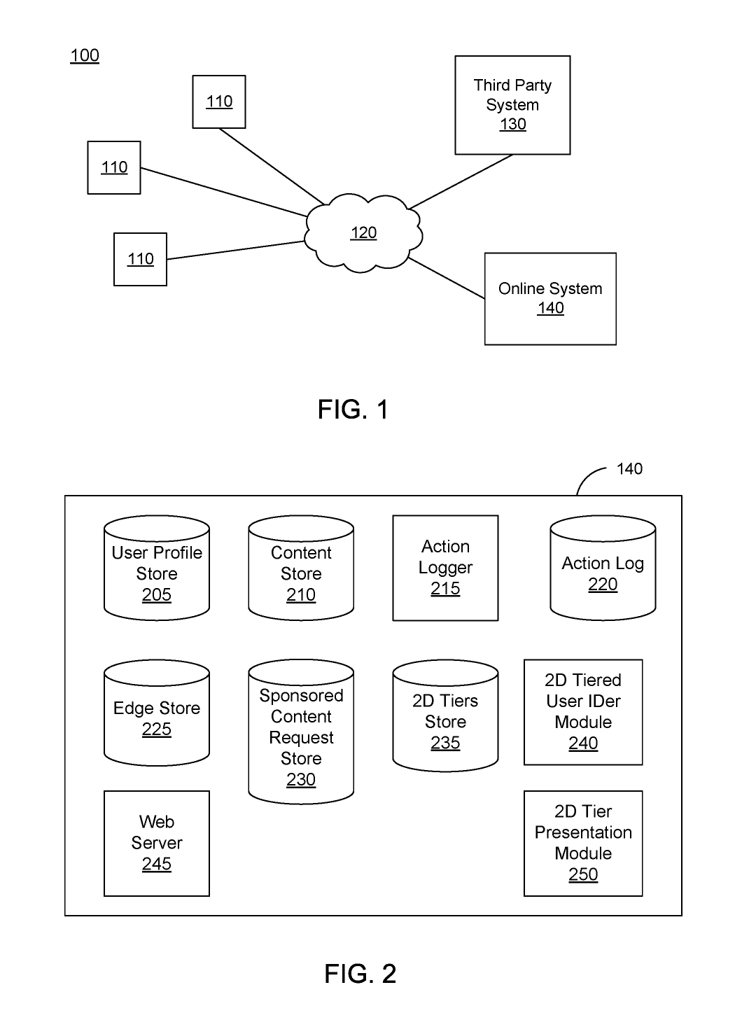

FIG. 1 is a high level block diagram of a system environment 100 for an online system 140, according to an embodiment. The system environment 100 shown by FIG. 1 comprises one or more client devices 110, a network 120, one or more third-party systems 130, and the online system 140. In alternative configurations, different and/or additional components may be included in the system environment 100. In one embodiment, the online system 140 is a social networking system.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130, such as a sponsored content provider system, may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the online system 140, such as advertisements, content, or information about an application provided by the third party website 130. Specifically, in one embodiment, a third party system 130 communicates sponsored content, such as advertisements, to the online system 140 for display to users of the client devices 110. The sponsored content may be created by the entity that owns the third party system 130. Such an entity may be an advertiser or a company producing a product, service, message, or something else that the company wishes to promote.

FIG. 2 is an example block diagram of an architecture of the online system 140, according to an embodiment. The online system 140 shown in FIG. 2 includes a user profile store 205, a content store 210, an action logger 215, an action log 220, an edge store 225, a sponsored content request store 230, a 2D tiers store 235, a 2D tiered user identification module 240, a 2D tier presentation module 250, and a web server 245. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding user of the online system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 140 displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system, events, groups or applications. In some embodiments, objects are received from third-party applications or third-party applications separate from the online system 140. In one embodiment, objects in the content store 210 represent single pieces of content, or content “items.” Hence, users of the online system 140 are encouraged to communicate with each other by posting text and content items of various types of media through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions are stored in the action log 210. Examples of interactions with objects include: commenting on posts, sharing links, and checking-in to physical locations via a mobile device, accessing content items, and any other interactions. Additional examples of interactions with objects on the online system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website that primarily sells sporting equipment at bargain prices may recognize a user of an online system 140 through a social plug-in enabling the e-commerce website to identify the user of the online system 140. Because users of the online system 140 are uniquely identifiable, e-commerce websites, such as this sporting equipment retailer, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, an edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system, sharing a link with other users of the online system, and commenting on posts made by other users of the online system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's affinity for an object, interest, and other users in the online system 140 based on the actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The sponsored content request store 230 stores one or more sponsored content requests. Sponsored content is content that an entity (i.e., a sponsored content provider) presents to users of an online system and allows the sponsored content provider to gain public attention for products, services, opinions, causes, or messages and to persuade online system users to take an action regarding the entity's products, services, opinions, or causes. In one embodiment, a sponsored content is an advertisement, and the sponsored content request store 230 stores advertisement requests (“ad requests”). An ad request includes advertisement content, also referred to as an “advertisement” and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an ad request by an advertiser (who may be the entity providing the sponsored content) and is used to determine an expected value, such as monetary compensation, provided by an advertiser to the online system 140 if advertisement content in the ad request is presented to a user, if the advertisement content in the ad request receives a user interaction when presented, or if any suitable condition is satisfied when advertisement content in the ad request is presented to a user. For example, the bid amount specifies or is used to compute a monetary amount that the online system 140 receives from the advertiser if advertisement content in an ad request is displayed. In some embodiments, the expected value to the online system 140 of presenting the advertisement content may be determined by multiplying the bid amount by a probability of the advertisement content being accessed by a user.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an advertisement request. As another example, targeting criteria identifies users having a connection to another user or object or having a particular type of connection to another user or object.

The two-dimensional (2D) tiered user identification module 240 identifies users of the online system 140 and categorizes these identified users into multi-dimensional tiers based on a similarity with a seed group of users. Initially, the 2D tiered user identification module 240 identifies a group of seed users for a sponsored content. These seed users are users that are expected to have high value for an entity's sponsored content. The value of each seed user may be measured in terms of return on investment (ROI) (e.g., how much revenue the user generates vs. the cost to present the sponsored content to the user), or may represent any other type of benefit to the entity providing the sponsored content (i.e., the sponsored content provider), such as a number of times a user purchased an item indicated in the sponsored content. In one embodiment, the sponsored content provider provides this value for each user as an initial score. In another embodiment, the online system 140 determines the value for each seed user based on the actions of the seed user in the online system 140.

In one embodiment, the 2D tiered user identification module 240 identifies these users based on information provided by the third party system 130 for a sponsored content. In another embodiment, the 2D tiered user identification module 240 identifies these users and each user's value based on other factors, such as the actions of users of the online system with regards to a sponsored content or other similar sponsored content.

After identifying the seed users, the 2D tiered user identification module 240 determines similar or lookalike users for the seed users. In one embodiment, the system finds lookalikes for the entire seed set of users. In another embodiment, the system first divides the seed set of users into high and low value, and then determines lookalike users for the high value portion of the seed set. In this embodiment, the system determines a threshold value dividing the seed users into a set of high value seed users and a set of low value seed users. To determine the threshold value, the 2D tiered user identification module 240 may begin with a best guess based on a default value or based on a characteristic of the initial scores of the seed users. For example, the default value could be one standard deviation above an average value of the seed users. Subsequently, the threshold value may be adjusted iteratively by the 2D tiered user identification module 240 to arrive at a more optimal value.

The 2D tiered user identification module 240 identifies users or lookalikes similar to the seed users or similar to the high value seed users above the threshold score (dividing the users into high value and low value seed users). The 2D tiered user identification module 240 identifies characteristics for the seed users. It can identify characteristics for all seed users, for the two groups of seed users (low and high value), or for just the high value users. The characteristics for each seed user may include various actions that the seed user has performed with regard to the online system 140. In one embodiment, the characteristics include information about the user in the user profile store 205, content store 210, action log 220, and edge store 225. Examples of such actions may include posts that the user has commented on, links that the user has shared, content items that the user has consumed, pages that the user has liked, etc.

The 2D tiered user identification module 240 identifies a group of additional high value users who have a similarity to the seed users, such as the group of high value seed users, based on similar characteristics shared between these two groups of users. The 2D tiered user identification module 240 then assigns a score for each of these additional high value users based on the level of similarity of the characteristics.

The 2D tiered user identification module 240 also identifies another group of users for the engagement portion of the 2D grid. This group is referred to here as additional engaged users. These users can be lookalikes have a similarity to the group of seed users as a whole, based on similar characteristics shared between these two groups. The 2D tiered user identification module 240 also scores each of the additional engaged users based on the level of similarity between each additional engaged user and the group of seed users. In another embodiment, the content provider can provide an initial score on engagement for each of the seed users, where users who engage frequently with content of the third party system have higher scores than users who do not, and a threshold score can be determined to divide users into high and low engagement seed groups, and then the additional engaged users can be lookalikes for the high engagement group.

The additional high value users are presumed to have potentially high value to the sponsored content provider due to their similarity with users of the seed group of users that have a value exceeding the threshold score. These additional high value users may likely perform actions in the online system 140 that produce high value for the sponsored content provider. For example, a group of high value users may have high conversion rates for an advertiser that identified the group of seed users to the online system 140.

The additional engaged users are presumed to have engaged with sponsored content from the sponsored content provider. As used here, a user who has engaged with sponsored content may be a user who has performed any type of action with or related to a sponsored content within the online system 140, or external to the online system 140, that has been tracked by the online system (e.g., via the action log 215, or via a tracking pixel embedded in a web page that includes the sponsored content).

Users who have engaged with the sponsored content may not necessarily have high value to the sponsored content provider. For example, a user may interact with a sponsored content to browse for products provided by the sponsored content provider (e.g., shop), but may not actually purchase (or purchase very few) of the products sold by that sponsored content provider. Alternatively, users may be of high value but be of low engagement. For example, a user may quickly purchase many items sold by a sponsored content provider and thus be deemed to be high value, but may not explore any other items being provided by that sponsored content provider, and thus be deemed low engagement. A sponsored content provider may thus wish to target these different groups of individuals with different strategies (e.g., different campaigns).

To allow the sponsored content provider to identify these different groups of users and thus potentially target them differently, the 2D tiered user identification module 240 determines whether any of the additional high value users and additional engaged users are the same users. In other words, the 2D tiered user identification module 240 determines whether any intersections exist between the additional high value users and the additional engaged users. Each of these intersections of user(s) may have a value score determined based on their similarity to the high value seed users, and a separate engagement score determined based on their similarity to the entire group of seed users. In one embodiment, the 2D tiered user identification module 240 also computes a combined score for each intersection based on the value score and the engagement score. For example, the total score may be weighted towards either the engagement score or value score based on a preference of the sponsored content provider.

If the 2D tiered user identification module 240 does not find any intersections between any of the additional engaged users and the additional high value users, the 2D tiered user identification module 240 may adjust (i.e., iterate) the threshold value above until intersections are identified. The 2D tiered user identification module 240 may perform a binary search or other process in order to arrive at a threshold value having the most number of intersections, or may iterate the threshold value using some other method to arrive at an optimal value.

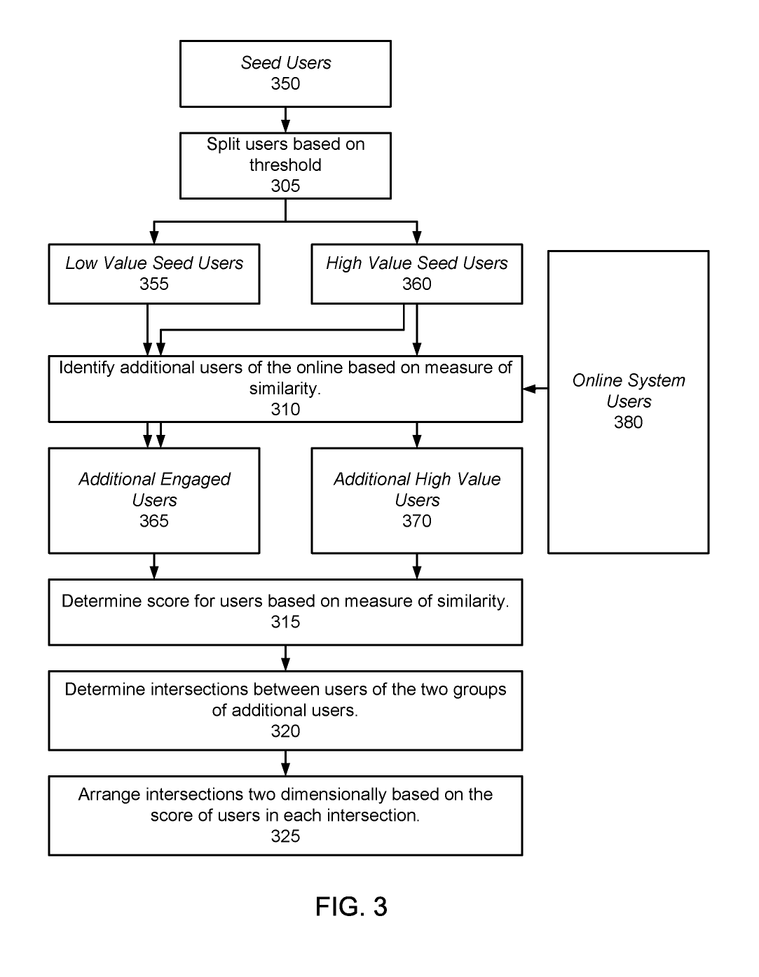

Additional details regarding the 2D tiered user identification module 240 will be described with reference to FIG. 3 and FIG . 4.

The 2D tier presentation module 250 presents the intersections of the additional high value users and the additional engaged users as created by the 2D tiered user identification module 240 to an entity, such as a sponsored content provider. When a sponsored content provider wishes to present the sponsored content to certain users, as described above, the sponsored content provider may wish to target users differently depending upon their predicted engagement levels and predicted value. The 2D tier presentation module 250 may show or provide for display to the sponsored content provider a display interface including the intersections of users between the additional high value users and additional engaged users that have been determined by the tiered user identification module 240 from the identified set of seed users. As each intersection includes users with a certain value score and a certain engagement score, the intersections may be arranged according to the score. For example, the intersections may be represented in a grid, with users in one axis ordered by their value score, and users in the other axis ordered by their engagement score. Intersections between the users are displayed as intersections in the 2D plane of the grid. For example, those users with high engagement but low value may be located at an intersection that has a high score on the engagement axis but a low score on the value axis.

In one embodiment, the 2D tier presentation module 250 further groups the intersections of users into one or more 2D tiers, with each 2D tier representing 1% of the total population of users for which the additional users were identified from. The total population of users may be a group of users of the online system 140 within a certain geographic area. Thus, each 2D tier may include a fixed (or similar) number of users. In other words, the 2D tier presentation module 250 divides the intersections of users into equal (or roughly equal) divisions. The 2D tier presentation module 250 may also indicate for each 2D tier a value and/or engagement statistic for the users within the 2D tier. For example, the 2D tier presentation module 250 may indicate a predicted return on investment (ROI) for each tier. This allows the entity to easily ascertain the tiers of users for which the entity would like to present the sponsored content to.

The 2D tiers store 235 stores information about the additional engaged users and additional high value users that have been identified by the 2D tiered user identification module 240. In addition to storing identifying information for these additional engaged users and additional high value users, the 2D tiers store 235 may store an association between each user and the intersection and/or 2D tier that the user has been identified to be a part of as described above. The 2D tiers store 235 may also store, for each intersection and/or 2D tier, metadata about that tier, such as the ROI, score of users within that 2D tier, and other data.

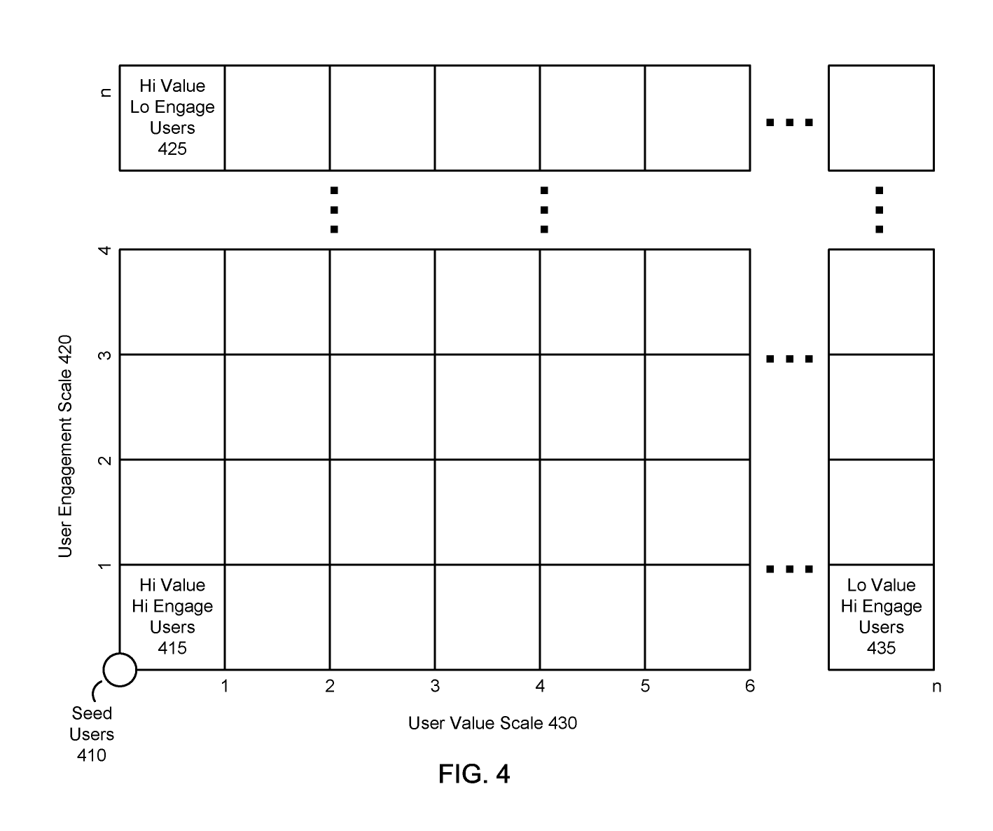

Additional details regarding the 2D tier presentation module 250 and the 2D tiers store 235 will be described with reference to FIG. 3 and FIG. 4.

The web server 245 links the online system 140 via the network 120 to the one or more client devices 110, as well as to the one or more third party systems 130. The web server 140 serves web pages, as well as other web-related content, such as JAVA®, FLASH®, XML and so forth. The web server 245 may receive and route messages between the online system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, WEBOS® or RIM®.

### Grouping Users Based on Multi-Dimensional Value and Engagement Factors

FIG. 3 is a flowchart of one embodiment of a method in an online system for grouping users based on multi-dimensional value and engagement factors, according to an embodiment. In other embodiments, the method may include different and/or additional steps than those described in conjunction with FIG. 3. Additionally, in some embodiments, the method may perform the steps described in conjunction with FIG. 3 in different orders. In one embodiment, the method is performed by one or more of the modules of the online system 140 described above.

Initially, the online system 140 identifies seed users 350 of the online system 140 who provide value to a sponsored content provider (e.g., an entity that can control the third party system 130).

In one embodiment, the online system 140 receives information from the third party system 130 directly identifying a plurality of users as the seed users 350. This information includes any information that may uniquely identify a user, such as an email address, social network username, unique identifier, contact information, address, phone number, name, and so on. For example, the third party system 130 may provide to the online system 140 a list of email addresses associated with users that the sponsored content provider considers to be of high value. This value may be in regards to a particular sponsored content of the sponsored content provider, or generally for the sponsored content provider.

Once the online system 140 has the list of users, the online system 140 can identify or determine the identity of these users by matching them to user profiles stored in a user profile store of the online system 140 (e.g., user profile store 205), assuming the users on the list from the third party system 130 are also users of the online system and hence have user profiles in the online system. The online system 140 identifies these matched users as part of a seed group of users. For example, the online system 140 can match the email address of a user provided by the third party system 130 to an email address in the user profile store to determine that it is the same user. In some cases, not all of users are users of the online system 140, in which case the online system 140 may be unable to identify certain of the users within the online system. These users may be excluded from the seed user group.

In one embodiment, to identify these seed users, the online system 140 receives a business rule(s) from the third party system 130 that identifies users to be placed in audience groups. An audience group is group of one or more users having at least one common characteristic, such as performing a specific type of interaction with content. Examples of interactions include a user visiting a particular page or content, a number of times a user visits a particular page of a website, a user accessing a particular advertisement, a user performing a specified type of action on an application associated with a third party system 130, etc. In one embodiment, an audience group identifier is stored in the user profile store of the online system 140 and is associated with user identifying information of users in the corresponding audience group.

A business rule specifies criteria for generating one or more audience groups including one or more users of the online system 140 and may be provided by the third party system 130. In one embodiment, one or more business rules identify characteristics of users included in an audience group. Examples of business rules include a user in an audience group based on a time elapsed between a current time and a time when a user performed a specific type of interaction, based on types of actions performed by the user with content provided by a third party system 130 (e.g., viewing a page from a website, clicking, interactions with an application, etc.), based on language of content presented to the user (e.g., a French version of website versus an English version of the website), or any other suitable criteria. In some embodiments, a custom audience tool is used to identify the audience groups.

After receiving a business rule identifying seed users, the online system 140 uses the business rule to identify those users with profiles in the online system 140 that satisfy the criteria of the business rule, and identifies these users as being part of an audience group of seed users.

In one embodiment, to identify these seed users, the online system 140 receives identifiers from the third party system 130 that may be used to identify the seed users. The third party system 130 uses a hash function to create a secure identifier hash for each of the users the third party system 130 identifies as seed users. This secure identifier hash does not include personally identifiable information for the user. The third party system 130 then transmits the generated secure identifier hashes to the online system 140. The online system 140 uses an equivalent hashing module to create a locally generated secure identifier hash for users of the online system 140. If the locally generated secure identifier hash matches any of the secure identifier hashes received from the third party system 130, the user of the online system 140 that is identified by the locally generated hash is identified as a seed user.

Methods of identifying users by a third party system are further described in U.S. patent application Ser. No. 13/306,901, filed on Nov. 29, 2011, U.S. patent application Ser. No. 14/034,350, filed on Sep. 23, 2013, U.S. patent application Ser. No. 14/177,300, filed on Feb. 11, 2014, and U.S. patent application Ser. No. 14/498,894, filed on Sep. 26, 2014, all of which are hereby incorporated by reference in their entirety.

In one embodiment, the online system 140 itself identifies seed users (or users expected to be of high value to the third party) without input by the third party system 130. The online system 140 can do this by, for example, determining if the actions performed by users after being presented with the sponsored content from the third party system 130 exceed a specified metric.

The actions performed by the users are logged by the online system 140 as described above, and can include actions such as liking, sharing, and otherwise engaging with the sponsored content or objects in the online system 140 that are related to the sponsored content. In one embodiment, the objects that are related to the sponsored content are within a certain degree of connections to the sponsored content. The connections may be stored as edges of the online system 140 as described above.

The actions may also include actions performed outside the online system 140 regarding the sponsored content, such as installing an application on a client device that was promoted by the sponsored content, visiting a web page or other location promoted by the sponsored content, and so on. This information may be provided by the third party system 130 or tracked by the online system 140 using a tracking identifier placed on the user's client device.

The online system 140 determines if the actions performed exceed a certain metric. The metric may be a threshold count of actions, a threshold number of actions made against the sponsored content, a threshold number of actions performed outside the online system 140, and/or any other relevant metric that may be used to measure the value of the user in response to being presented by the sponsored content.

The metric may be an amount of profit (e.g., ROI) generated by the user' actions for the third party system 130 as a result of being presented with the sponsored content. In one embodiment, the ROI for users is calculated by the third party system 130 and provided to the online system. The online system 140 identifies the users of the online system that match the users provided by the third party system 130 (e.g., by matching characteristics of the user's profile with the information provided by the third party system 130), and selects those users that exceed a certain ROI value (e.g., top 1% of ROI among the ROI values provided) as the seed users.

In one embodiment, the third party system 130 provides the online system 140 with estimated revenue for certain types of actions related to the sponsored content, and the online system 140 calculates the estimated revenue for each user based on the actions performed by that user. Those users that exceed a certain estimated revenue are then selected by the online system 140 as seed users.

In one embodiment, the online system 140 removes from the group of seed users those users that have shown a period of inactivity within the online system 140 or a period of inactivity with regards to the sponsored content provider.

For each seed user that is identified, the online system 140 also identifies a score for that seed user that represents a value of that user to the sponsored content provider. As noted above, the value of a user is any benefit that the user provides to the sponsored content provider. This benefit may represent clicks per impression for the user, ROI for the user, conversion rate for the user (per impressions), revenue generated for the user, time spent at a location of the sponsored content provider, and so on. The benefit may be defined by the sponsored content provider, and received from the third party system 130, or may be determined by the online system 140 based on some default configuration (e.g., clicks per impression may be used as the default benefit measured for each user).

The score for each seed user may be provided by the sponsored content provider via the third party system 130 or determined by the online system 140. In one embodiment, the score is provided by the third party system 130. This score may directly represent some real statistic measured by the sponsored content provider, such as the revenue generated by each user, or it may represented an abstracted score that the third party system 130 generated based on that statistic, as the sponsored content provider may wish to keep some information confidential. For example, the third party system 130 may provide the score as a normalized version of one of the real statistic values.

In another embodiment, the online system 140 determines a score for one or more of the seed users, or as a second score for one or more of the seed users to supplement the score provided by the third party system 130. To determine a score for each identified seed user in the online system 140, the online system 140 may give a weighted value to each action performed by that seed user in the online system 140 in connection with the sponsored content provider. These may be any actions that the online system 140 may track and which are connected with a particular sponsored content, campaign, group of sponsored content, or other element of the sponsored content provider that the online system 140. For example, an action may include a user clicking on a sponsored content of the sponsored content provider, or may include a user liking a page owned by the sponsored content provider. The weighted value of each action for the seed user may be combined into a score for that seed user (e.g., by adding the weighted values into a normalized score). In other embodiments, the online system 140 determines the score using a different method.

Once the group of seed users is identified, and the scores for each of the seed users is identified, the online system 140 identifies a threshold score to divide 305 the seed users into a group of low value seed users 355 and a group of high value seed users 360. In one embodiment, the threshold score is received from the third party system 130 of the sponsored content provider. In one embodiment, the online system 140 identifies not a single group of seed users, but instead identifies the group of low value seed users 355 and the group of high value seed users 360 based on information directly received from the third party system 130 (i.e., the third party system 130 provides the two groups of seed users and thus a threshold value is not identified).

In one embodiment, the online system 140 identifies as the threshold score an initial score value. The initial score value may be a default value, such as a score representing ½ of the maximum score, or may be based on the scores that have been determined for the seed users. In one case, the threshold value is determined based upon a statistical analysis of the scores of the seed users. This may involve analysis of the standard deviation, mean, median, variance, or other information regarding the scores of the seed users. For example, the threshold score may be set to be one standard deviation higher than the mean of the scores of the seed users.

In one embodiment, the threshold score is a “soft” threshold rather than a “hard” threshold. Thus, the online system 140 may determine a threshold score and allow certain users to be placed in the high value seed user group 360 rather than the low value seed user group 355 if the score of the user is near enough to the threshold and within a particular range (e.g., a percentage of the total score), or vice versa. Each user may be randomly assigned to either the high value or low value seed group when the user's score is near the threshold score by a certain range, or those users with a score near the threshold score may be assigned to a group that it would not have been assigned to otherwise if a particular attribute of the user or profile of the user indicates that the user should belong to the other group. For example, if a user has a score near the threshold score but at the lower end of the range, that user may be placed in the high value seed user group 360 instead of the low value seed user group 355 if that user has been determined to have generated a high amount of revenue for the sponsored content provider.

In other embodiments, the online system 140 generates a threshold range directly instead of a threshold score, with the determination of which group a seed user is to be placed proceeding as described above.

In one embodiment, once the seed users 350 have been divided into a low value seed user group 355 and a high value seed user group 360, the online system 140 identifies 310 additional engaged users 365 from the users 380 of the online system 140 that have at least a threshold measure of similarity to the combined low value seed user group 355 and the high value seed user group 360 (i.e., the seed users 350). The online system 140 assumes that the entire group of seed users 350 has engaged with some aspect of the sponsored content provider's content, as the sponsored content provider identified these users as having some value to the sponsored content provider. Thus, the entire group of seed users is used to determine the additional engaged users. The online system 140 also identifies 310 additional high value users 370 from the users 380 of the online system 140 that have at least a threshold measure of similarity to the high value seed users 360.

In another embodiment, the sponsored content provider via the third party system 130 provides the online system 140 with a group of engaged users and a group of high value users (i.e., two separate sets of “seed” users). Once the online system 140 receives these two groups of users, the online system 140 identifies 310 the additional high value users 370 as those that have at least the threshold measure of similarity to the provided group of high value users, and identifies 310 the additional engaged users 365 as those that have at least the threshold measure of similarity to the provided group of engaged users.

Note that this engagement may include interactions between the seed users and the content of the third party system stored at the online system, or may also include interactions performed at the third party system, for which data of those interactions have been received by the online system 140 (e.g., via a tracking pixel or app events). In particular, these interactions may include conversions made at the third party system. Conversions may include purchases or other actions performed by users that the third party system would prefer to measure. Thus, the engaged users (whether the additional engaged users or the engaged users provided by the third party system) may have a high propensity to convert, but may not necessarily be of high value to the third party system.

In one embodiment, the online system 140 determines that a group of additional users (e.g., additional high value users 370) has at least a threshold measure of similarity to an initial group of users (e.g., high value seed users 360) based on users in the additional group of users having at least a threshold number or percentage of characteristics matching or similar to characteristics of the users in the initial group. These characteristics may include interests of each user, which may be stored in user profiles of the users. Similarly, the online system 140 may identify as additional users those users who interacted with content items of the online system 140 having at least a threshold number or percentage of characteristics matching characteristics of content items with which users of the initial group interacted. Other characteristics can also be utilized, such as matching demographics between users, similar affinity scores for particular content or types of content, connections to similar content or users, similar patterns of interacting with content, etc.

The online system 140 may train and apply a model to the characteristics of the initial group of users and the content items with which the initial group of users have interacted. The model may be any type of statistical model that can make a prediction (e.g., in the form of a percentage) of a similarity of characteristics of a user of the online system 140 to the characteristics trained in the model. For example, a model may predict the similarity based on how many characteristics are shared between two users out of a total number of characteristics logged by the online system 140. Using the model, the online system 140 identifies additional users that have a threshold measure of similarity to the initial group of users.

The actual threshold value for the threshold measure of similarity may be set at a particular number of sigmas of a standard deviation of all (or a random sampling of) users of the online system 140 as measured using the measurement for the threshold measure of similarity. Alternatively, the threshold measure may be set to the average value of all (or a random sampling of) users of the online system 140 as measured using the measurement for the threshold measure of similarity.

Additional methods of determining similarity between groups of users of an online system are further described in U.S. patent application Ser. No. 13/297,117, filed on Nov. 15, 2011, U.S. patent application Ser. No. 14/290,355, filed on May 29, 2014, U.S. patent application Ser. No. 14/719,780, filed on May 22, 2015, all of which are hereby incorporated by reference in their entirety.

In one embodiment, the seed users and different groups of additional users that are identified by the online system 140 are limited to a particular geographical area. The geographical location of each user may be determined by the online system 140 using information in the user's user profile or using other methods such as IP geolocation.

Once the online system 140 identifies the seed users and the additional users, the online system further determines 315 a value score for each of the additional high value users and an engagement score for each of the additional engaged users based at least in part on the measure of similarity that the online system 140 had previously identified for each user to the respective group of seed users as described above. In one embodiment, the score is a scaled value, with those users nearest the previously determined threshold measure (or range) of similarity receiving a lowest score in the scale, and those users with a measure of similarity closest to the seed users receiving the highest score in the scale. In one embodiment, the score is a percentage scale from 0% to 100%, with users closest to the seed users receiving a percentage value of 100% (or 99%, with the seed users receiving a score of 100%), and those users at the threshold measure of similarity receiving a score of 1% or 0%.

Subsequently, the online system 140 determines 320 one or more intersections between the two groups of additional users, i.e., the additional high value users 370 and the additional engaged users 365. Each intersection includes those users that are present both in the additional high value users 370 and the additional engaged users 365.

The online system 140 may group the users within each intersection such that each intersection includes users with value or engagement scores that form a contiguous range of scores. For example, a first intersection may have the users with a range of highest value scores, a next intersection may have a range of users with the next highest value scores. Additionally, these intersections may each have users that are within a range of engagement scores or are within different ranges of engagement scores. Using this grouping, the entire range of value scores and engagement scores for the users are divided into different intersections. The online system 140 may further group the additional users such that the intersections do not have overlapping value or engagement scores.

The online system 140 may also group the users within each intersection such that a certain number of users are grouped within each intersection. This number may correspond to a percentage of the total number of additional users that have been identified by the online system 140, or a total number of users within the online system 140, or within the geographical location of the seed users.

In one embodiment, in order to determine the intersections, the online system 140 identifies those additional high value users 370 that are also (i.e., match) the additional engaged users 365. These users are divided into the one or more intersections such that each intersection includes users with a range of value scores that is contiguous with the value scores of another intersection, and includes users with a range of engagement scores that are contiguous with another intersection. Additionally, each intersection may have the same number of users (or approximately the same within a threshold value).

Although two scores based on measures of similarity to two groupings of seed users is described here, in other embodiments the online system 140 may measure similarity to additional groupings of seed users. These groupings may be intended to represent other factors other than the engagement or high value to the sponsored content provider, and may represent factors such as dislike (i.e., users who dislike the sponsored content provider based on an analysis of their actions), certain demographic or profile features common to users (e.g., gender, age, amount of income, etc.), and so on.

In one embodiment, the online system 140 modifies the original threshold score based on an unsatisfactory determination 320 of the intersections. The online system 140 may determine that very few intersections (e.g., below a threshold or percentage) exist between the additional high value users 370 and the additional engaged users 365.

As an example, a user may have both a value score and an engagement score. In such a case, the user may be grouped such that the intersection that the user belongs includes other users with similar value scores within a particular range. However, the other users in that intersection do not have engagement scores that are within a similar range of the current user. The online system 140 attempts to place the user in a different intersection that has users with similar value and engagement scores, however, such a different intersection may not exist. If too many users cannot be placed in intersections, the online system 140 may adjust the threshold score.

As another example, when the online system 140 matches the additional high value users 370 with the additional engaged users 365, the online system 140 may determine that the number of matches found is below a threshold value. In such a case, the online system 140 may adjust the threshold score.

To adjust the threshold score, the online system 140 may adjust the threshold score up or down in intervals or using a fast convergence process to determine a threshold score that results in a determination of intersections that have more (or a maximum number) of the users in common from both the additional high value users and the additional engaged users, or which results in more matches between the additional high value users 370 and the additional engaged users 365.

In another embodiment, the online system 140 may “holdout,” or leave out some (e.g., some percentage such as 5%) of the seed users 350 received from the third party system 130. Upon determining the intersections of the additional groups of users, the online system 140 determines whether any of these held out seed users match any users within any of the intersections, and whether these intersections are those with users that have value and/or engagement scores that are high. The assumption may be that the held out seed users should have been determined to have a high measure of similarity to the seed users 350, and thus should at least have high value score or high engagement score as determined using the process described above. If this is not the case, then the online system 140 modifies threshold score up or down such that these held out seed users are within an intersection with users that have value and engagement scores that are high.

In one embodiment, the online system 140 determines whether the threshold score is acceptable by observing real world data regarding the users placed into the various intersections. If those users match their respective value and/or engagement scores, the online system 140 may determine that the threshold score is good. Otherwise, the threshold score may be modified up or down. The online system 140 may determine that the users match their scores when relatively speaking, users with higher value scores generate more value for the sponsored content provider than users with low value, and users with high engagement scores engage more with the sponsored content provider compared to users with lower engagement scores.

The online system 140 may iteratively modify the threshold score multiple times, in both directions, until a threshold score that produces a good set of intersections is identified.

In one embodiment, the online system 140 provides 325 for display to the sponsored content provider the one or more determined intersections. In one embodiment, the intersections may be presented by the online system 140 in a two-dimensional grid format, with one axis of the grid representing a value score, and an orthogonal axis representing an engagement score. An intersection is placed on this grid according to the range of engagement and value scores of that intersection, such that the scores align with the scores indicated in the axes. An example of such a grid is illustrated in FIG. 4. In another embodiment, the online system 140 does not present all the intersections to the sponsored content provider, but instead allows the sponsored content provider to select one or more of the intersections using a slider interface, with one slider indicating an engagement score, and another indicating a value score. The online system 140 selects those intersection(s) having users that fall within or near the indicated engagement score and value score and may allow the online system 140 to specifically target these users with sponsored content. In one embodiment, the online system 140 allows the sponsored content provider to adjust the sizes and score ranges of users within each intersection.

In one embodiment, the online system 140 also computes the ROI for each intersection. In one embodiment, the online system 140 computes the ROI for each intersection based on the compensation the online system 140 received from the sponsored content provider for users in each tier in exchange for presenting the users with the sponsored content from the sponsored content provider, as well as the revenue received from each user by the sponsored content provider.

The revenue received by the entity may be provided directly by the sponsored content provider. Alternatively, the online system 140 may compute this revenue information based on a typical ROI percentage for a sponsored content presented by the online system 140 to a user, along with information regarding how many users in that tier are likely to perform a revenue-generating action in relation to the sponsored content in response to being presented with the sponsored content. The online system 140 may also estimate the revenue information based upon information about the sponsored content provider's industry, the type of sponsored content, how closely the users in the intersection match the targeting criteria of the sponsored content and so on.

After the online system 140 presents the intersections to the sponsored content provider, the sponsored content provider may target the users within each intersection differently according to the engagement score or value score of the users in that intersection. Users with a high value score but low engagement score may provide a high value (e.g., generate significant revenue) for the sponsored content provider, but may not engage (e.g., spend time) significantly with the sponsored content provider (e.g., spend time at the sponsored content provider's page on the online system, or spend time at the sponsored content provider's web page, etc.) The sponsored content provider may wish to target these users differently by presenting them with content that promotes additional engagement. Conversely, for users with high engagement scores but low value scores, the sponsored content provider may wish to present these users with content that promotes value by exploiting their high engagement (e.g., convinces them to purchase items using various engagement methods).

In one embodiment, instead of directly presenting the intersections for display to the sponsored content provider, the online system 140 provides an application programming interface (API) that the sponsored content provider may user to retrieve data regarding the intersections as described above.

Thus, such a method and system of presenting a sponsored content provider with a multi-dimensional analysis of users of the online system 140 allows the online system 140 to 1) present to the sponsored content provider more detailed characteristics regarding an initial set of users that the sponsored content provider is targeting while also 2) allowing the sponsored content provider to expand its reach to target additional users of the online system 140 that are similar to these initial set of users using this multi-dimensional analysis. This may allow the sponsored content provider to better target users and generate a higher return on their investment.

Although value has been described here in reference to a value defined by a third party system, and engagement has been described here in reference the engagement of users with a third party system, in other embodiments the values which are used for the intersections may be any type of signal supported by the online system 140, provided by the third party systems 130, or otherwise available to the online system 140. These signals, when intersected, provide useful information about the characteristics of users of the online system 140 or other content in the online system 140, such as newsfeed articles, edges, and so on.

FIG. 4 illustrates a diagrammatic representation 400 of a set of intersections for additional high value users and additional engaged users, according to an embodiment. In one embodiment, this representation 400 is presented as a graphical representation of the set of users to a sponsored content provider.

The circle 410 in the bottom left represents the group of seed users used to initially determine the additional engaged users and additional high value users as described above. Each box in the grid represents an intersection of the additional high value users and the additional engaged users. Furthermore, in the illustrated embodiment, the boxes that are further away from the circle 410 of seed users are less similar to the seed users. Thus, for example, the box 415 represents an intersection including users that have high value scores and high engagement scores, while the box 435 have users that have high engagement but low value, and the box 425 represent users that have low engagement but high value. The user engagement scale 420 marks the vertical axis, and the user value scale 430 marks the horizontal axis. These may represent the engagement score and the value score, respectively, of users within the intersections in the grid. They may also represent a cumulative number (or percentage) of users of a population. A cumulative count on a point on the axis represents the cumulative number of users of all the boxes of users along the axis up to that point.

The online system 140 may present the grid as illustrated in FIG. 4 to a sponsored content provider that provided the seed users, via, for example, an application or web page. The online system 140 presents the sponsored content provider with one or more of the boxes, and information regarding one or more of the boxes. This information may include various metadata regarding the users in the intersections represented by the boxes, such as ROI, engagement time, revenue, demographics, and so on. Using this information, the sponsored content provider is able to select which box of users for which to present various sponsored content, the compensation (e.g., the bid) to the online system 140 for presenting the sponsored content for each intersection of users. As noted above, since each intersection has users with different engagement and value scores, the sponsored content provider may target users in different intersections differently.

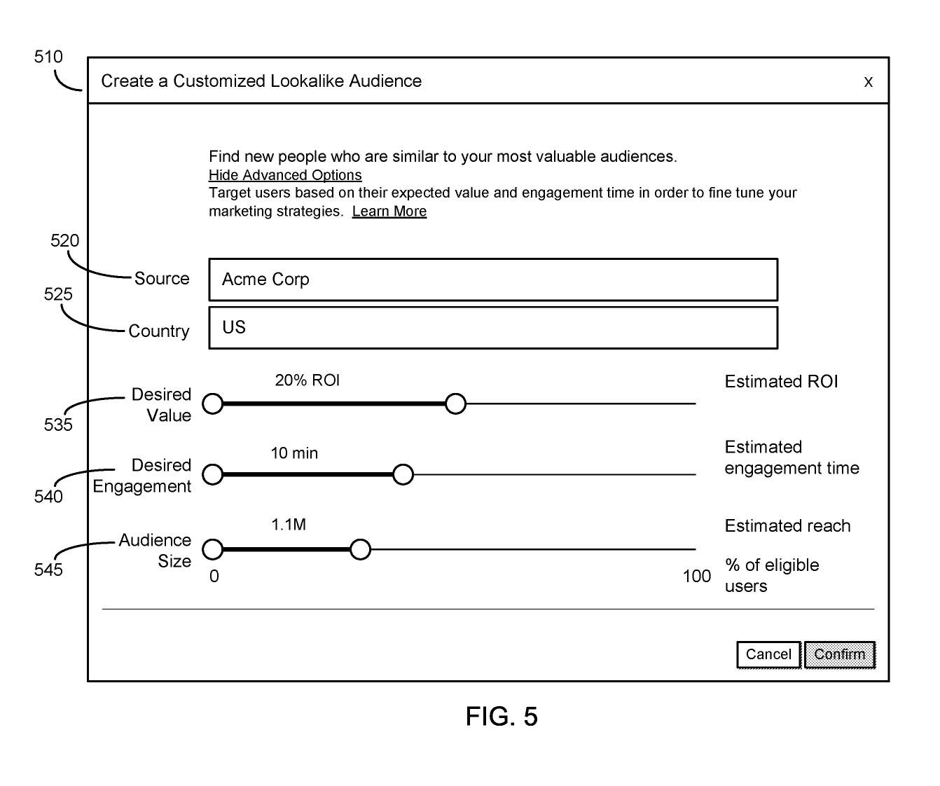

FIG. 5 illustrates an exemplary user interface 510 for configuring a multi-dimensional set of users, according to an embodiment. In other embodiments, the arrangement of elements in the user interface may be different.

The online system 140 presents the user interface (UI) 510 to a sponsored content provider. The online system 140 presents in the UI 510 a source selection 520 to allow the sponsored content provider to select a source (e.g., by providing suggested items as the user enters text or via a drop down menu). The source provided here may represent a source of seed users for which the online system 140 determines one or more groups of additional users as described above. The online system 140 also presents the entity with an option of a country selection 525 to select a geographic region to filter the users indicated in the source selection 520. The online system 140 may also use the country selection 525 as a filter when searching for additional users for determining the additional users as described above. If the entity does not select a country, the online system 140 may instead filter the users based on the geographic region of the source users selected in the source selection 520, or may search using all the users of the online system 140.

The online system 140 presents in the UI 510 a desired value slider 535 that allows the sponsored content provider to select a desired value score for the additional users that it wishes to target. The online system 140 also presents a desired engagement slider 540 that allows the sponsored content provider to select a desired engagement score for the additional users that it wishes to target. Using the values indicated by these sliders, the online system 140 selects one or more intersections of users as determined in the process described above that have engagement and value scores that match or are within a certain range of the scores indicate by the sliders.

The online system 140 may also present an audience size slider 545 that allows the sponsored content provider to select the size of the audience to select. The online system 140 selects a number of intersections having similar engagement and value scores to the scores indicated by the desired value slider 535 and the desired engagement slider 540 such that the number of users selected matches or is within a certain range of the audience size selected by the slider 545. Once these values are indicated, the online system 140 may in a separate UI prompt the sponsored content provider for the sponsored content that it wishes to target these users with, as well as the compensation (e.g., bid amounts) and other details that the sponsored content provider wishes to provide.

### Concluding Statements

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
identifying seed users of an online system for sponsored content of a content provider, each of the seed users associated with an initial score indicating a value of that seed user to the content provider;
identifying a threshold score dividing the seed users into low value seed users and high value seed users based on the initial score of each seed user;
identifying one or more characteristics of each of the low value seed users and the high value seed users;
identifying, as additional high value users, additional users of the online system having a measure of similarity to one or more of the high value seed users that is above a first threshold measure of similarity, a measure of similarity between two groups of users based at least in part on characteristics of one of the groups matching one or more identified characteristics associated with another of the groups;
identifying, as additional engaged users, additional users of the online system having a measure of similarity to one or more of the identified seed users that is above a second threshold measure of similarity;
determining a value score for each of the additional high value users, the value score for each additional high value user based at least in part on the measure of similarity between the additional high value user and the high value seed users, the additional high value users divided into value tiers according to the value scores;
determining an engagement score for each of the additional engaged users, the engagement score for an additional user based at least in part on the measure of similarity between the additional engaged user and the seed users, the additional engaged users divided into engagement tiers according to the engagement scores;
determining one or more intersections between the value tiers of users containing the additional high value users and the engagement tiers of the additional engaged users based on the scores; and
providing for display to the content provider the one or more of the intersections.

2. The method of claim 1, wherein the initial score associated with each user is computed by:
identifying, for each seed user, actions performed by that seed user in response to being presented with content provided by the third party system;
determining, for each seed user, the initial score weighted based on the actions performed by that seed user in response to being presented with content provided by the third party system.

3. The method of claim 1, wherein the identifying a threshold score dividing the seed users further comprises:
computing an average of the initial scores for each seed user; and
identifying the threshold score as one standard deviation above the average score.

4. The method of claim 1, wherein the determining one or more intersections further comprises:
identifying the additional high value users matching the additional engaged users; and
dividing matched users into the one or more intersections, each intersection including matched users with a range of engagement scores that is contiguous with a range of engagement scores corresponding to another intersection, each intersection including matched users with a range of value scores that is contiguous with a range of value scores corresponding to another intersection.

5. The method of claim 1, further comprising:
determining that the one or more intersections have a number of users below a threshold value; and
adjusting the threshold score iteratively such that each of the one or more intersections that is subsequently determined has a maximum number of users.

6. The method of claim 1, further comprising:
determining that the one or more intersections have a number of users below a threshold value;
adjusting the threshold score iteratively such that a maximum number of additional engaged users matches the additional high value users; and
determining an updated one or more intersections of users, each intersection having one or more of those additional engaged users that match the additional high value users based on respective scores.

7. The method of claim 1, further comprising:
identifying a random selection of the seed users as users of a holdout group;
excluding the users of the holdout group during identification of the additional high value users and the additional engaged users;
in response to determining the one or more intersections, determining whether users of the holdout group match any of the users in any of the one or more intersections;
in response to determining that the match rate of the users in the holdout group is below a match threshold, adjusting the threshold score to increase the match rate;
in response to determining that the match rate of the users in the holdout group is above the match threshold, determining whether the matched users have value scores and engagement scores above a particular threshold; and
in response to determining that a certain number of the matched users do not have scores above the particular threshold, adjusting the threshold score to increase the scores for the matched users.

8. The method of claim 1, further comprising:
monitoring the actions of the users within the one or more intersections in the online system; and
adjusting the threshold score such that the engagement scores and value scores of the users in each intersection match the observed engagement and value generated by each user.

9. The method of claim 1, wherein the providing for display to the content provider further comprises:
presenting the one or more intersections in a two dimensional grid, each section of the grid representing one intersection, one axis of the grid indicating the value score of intersections along that axis, and an orthogonal axis indicating the engagement score of intersections along the orthogonal axis.

10. The method of claim 9, further comprising:
presenting within each grid section statistical information for the users of the corresponding intersection.

11. A computer program product comprising a non-transitory computer readable storage medium having instructions encoded thereon that, when executed by a processor, cause the processor to:
identify seed users of an online system for sponsored content of a content provider, each of the seed users associated with an initial score indicating a value of that seed user to the content provider;
identify a threshold score dividing the seed users into low value seed users and high value seed users based on the initial score of each seed user;
identify one or more characteristics of each of the low value seed users and the high value seed users;
identify, as additional high value users, additional users of the online system having a measure of similarity to one or more of the high value seed users that is above a first threshold measure of similarity, a measure of similarity between two groups of users based at least in part on characteristics of one of the groups matching one or more identified characteristics associated with another of the groups;
identify, as additional engaged users, additional users of the online system having a measure of similarity to one or more of the identified seed users that is above a second threshold measure of similarity;
determine a value score for each of the additional high value users, the value score for each additional high value user based at least in part on the measure of similarity between the additional high value user and the high value seed users, the additional high value users divided into value tiers according to the value scores;
determine an engagement score for each of the additional engaged users, the engagement score for an additional user based at least in part on the measure of similarity between the additional engaged user and the seed users, the additional engaged users divided into engagement tiers according to the engagement scores;
determine one or more intersections between the value tiers of users containing the additional high value users and the engagement tiers of the additional engaged users based on the scores; and
provide for display to the content provider the one or more of the intersections.

12. The computer program product of claim 11, having further instructions for the computation of the initial score that, when executed by a processor, cause the processor to:
identify, for each seed user, actions performed by that seed user in response to being presented with content provided by the third party system;
determine, for each seed user, the initial score weighted based on the actions performed by that seed user in response to being presented with content provided by the third party system.

13. The computer program product of claim 11, having further instructions for the identification of the threshold score that, when executed by a processor, cause the processor to:
compute an average of the initial scores for each seed user; and
identify the threshold score as one standard deviation above the average score.

14. The computer program product of claim 11, having further instructions for the determination of the one or more intersections that, when executed by a processor, cause the processor to:
identify the additional high value users matching the additional engaged users; and
divide matched users into the one or more intersections, each intersection including matched users with a range of engagement scores that is contiguous with a range of engagement scores corresponding to another intersection, each intersection including matched users with a range of value scores that is contiguous with a range of value scores corresponding to another intersection.

15. The computer program product of claim 11, having further instructions that, when executed by a processor, cause the processor to:
determine that the one or more intersections have a number of users below a threshold value; and
adjust the threshold score iteratively such that each of the one or more intersections that is subsequently determined has a maximum number of users.

16. The computer program product of claim 11, having further instructions that, when executed by a processor, cause the processor to:
determine that the one or more intersections have a number of users below a threshold value;
adjust the threshold score iteratively such that a maximum number of additional engaged users matches the additional high value users; and
determine an updated one or more intersections of users, each intersection having one or more of those additional engaged users that match the additional high value users based on respective scores.

17. The computer program product of claim 11, having further instructions that, when executed by a processor, cause the processor to:
identify a random selection of the seed users as users of a holdout group;
exclude the users of the holdout group during identification of the additional high value users and the additional engaged users;
in response the determination the one or more intersections, determine whether users of the holdout group match any of the users in any of the one or more intersections;
in response the determination that the match rate of the users in the holdout group is below a match threshold, adjust the threshold score to increase the match rate;
in response the determination that the match rate of the users in the holdout group is above the match threshold, determine whether the matched users have value scores and engagement scores above a particular threshold; and
in response to the determination that a certain number of the matched users do not have scores above the particular threshold, adjust the threshold score to increase the scores for the matched users.

18. The computer program product of claim 11, having further instructions that, when executed by a processor, cause the processor to:
monitor the actions of the users within the one or more intersections in the online system; and
adjust the threshold score such that the engagement scores and value scores of the users in each intersection match the observed engagement and value generated by each user.

19. The computer program product of claim 11, having further instructions for the providing for display to the content provider that, when executed by a processor, cause the processor to:
present the one or more intersections in a two dimensional grid, each section of the grid representing one intersection, one axis of the grid indicating the value score of intersections along that axis, and an orthogonal axis indicating the engagement score of intersections along the orthogonal axis.

20. The computer program product of claim 19, having further instructions that, when executed by a processor, cause the processor to:
present within each grid section statistical information for the users of the corresponding intersection.
